(19) United States
(12) Patent Application Publication
(10) Pub. No.: US 2010/0161348 A1
(43) Pub. Date: Jun. 24, 2010

(54) Clinical Management System

(75) Inventors: Debra Lindell, Plymouth, MN (US); Daniel W. Latham, Mason City, IA (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(73) Assignee: EMPATHIC SOFTWARE SYSTEMS, Wayzata, MN (US)

(21) Appl. No.: 12/642,072

(22) Filed: Dec. 18, 2009

Related U.S. Application Data
(60) Provisional application No. 61/203,161, filed on Dec. 19, 2008.

(51) Int. Cl. G06Q 50/00; G06Q 40/00; G06Q 10/00; G06F 17/30

(52) U.S. Cl. 705/2; 705/4; 707/767; 707/E17.014

(57) ABSTRACT

A system that receives a portion of the content of a clinical note in an active first field, switching the active first field to be inactive, searching at least one database based on the content of the clinical note, wherein searching is triggered upon switching the active first field to be inactive, and presenting one or more relevant results resulting from searching the at least one database on the clinical note. A clinical note system is also described that has client registration module, an insurance billing module and a clinical notes module.

This application is a non-provisional application claiming priority to U.S. Provisional Application No. 61/203,161, filed Dec. 19, 2008, and the entire contents of the U.S. Provisional Application are incorporated herein by reference.

### FIELD OF THE INVENTION

Generally the technology disclosed herein relates to a computerized system. More particularly the technology disclosed herein relates to a clinical management system.

### BACKGROUND

Clinical management software is generally used in the medical field to organize, store, and manage client and clinic data. Such software has become increasingly useful in providing a wide range of services to medical practitioners. However, some aspects of the software remain relatively tedious for medical practitioners.

### SUMMARY OF THE INVENTION

In one embodiment of the technology disclosed herein, the system receives at least a first entry in a first field of a clinical note. First data is appropriated from the first entry, and a search is conducted for the first data in at least one database. Searching for the first data is triggered upon receiving at least the first entry of the first field of the clinical note.

The system also receives at least a second entry in a second field of the clinical note and appropriates at least second data from the second entry. Searching for the first data and the second data in the at least one database is triggered upon receiving at least the second entry of the clinical note. The system also receives at least a third entry in a third field of the clinical note and appropriates at least third data from the third entry. Searching for the first data, the second data, and the third data in the at least one database is triggered upon receiving at least the third entry of the clinical note. Relevant results are presented through a user interface.

In another embodiment of the technology disclosed herein, a portion of the content of a clinical note is received in an active first field. Searching at least one database based on the content of the clinical note is triggered upon switching the active first field to be inactive. One or more relevant results resulting from searching the at least one database is presented.

In a final embodiment of the technology disclosed herein, the system has a client registration module for entry and storage of client data, an insurance billing module to appropriate at least a portion of client data to create an insurance claim and send an insurance claim, and a clinical notes module for receiving content of clinical notes regarding a client, appropriating at least a portion of client data to a clinical note, and triggering the insurance billing module to create an insurance claim upon completion of the clinical note.

### BRIEF DESCRIPTION OF THE DRAWINGS

The invention may be more completely understood and appreciated in consideration of the following detailed description of various embodiments of the invention in connection with the accompanying drawings.

FIG. 1 is a flow chart consistent with at least one embodiment of the technology disclosed herein.

FIG. 2 is a flow chart consistent with at least one alternative embodiment of the technology disclosed herein.

FIG. 3 depicts a schematic consistent with at least one embodiment of the technology disclosed herein.

FIG. 4 depicts another schematic consistent with at least one embodiment of the technology disclosed herein.

FIG. 5 is a first example screenshot related to client intake for a system consistent with the technology disclosed herein.

FIG. 6 is a second example screenshot related to client intake for a system consistent with the technology disclosed herein.

FIG. 7 is a third example screenshot related to client intake for a system consistent with the technology disclosed herein.

FIG. 8 is an example screenshot related to creation of a treatment plan for a system consistent with the technology disclosed herein.

FIG. 9 is an example screenshot related to preparation of a case note for a system consistent with the technology disclosed herein.

FIG. 10 is an example screenshot related to search results for a system consistent with the technology disclosed herein.

FIG. 11 is an example form consistent with the technology disclosed herein.

FIG. 12 is another example form consistent with the technology disclosed herein.

FIG. 13 is an example screenshot related to a financial center for a system consistent with the technology disclosed herein.

FIG. 14 is an example form consistent with the technology disclosed herein.

FIG. 15 is an example screenshot related to the financial center for a system consistent with the technology disclosed herein.

FIG. 16 is an example schematic of software access in a clinic consistent with one embodiment of the technology disclosed herein.

FIG. 17 is a schematic of example system components for practicing the technology disclosed herein.

### DETAILED DESCRIPTION

The technology disclosed herein is generally relevant to clinical notes and clinical note-taking. The term “clinical note” as used herein encompasses notes entered by any specialized or non-specialized health care provider or medical professional, such as medical technicians, psychologists, counselors, behavioral health professionals, social workers, doctors, nurses, and the like, about a patient or client based on an appointment, meeting, or other interaction with the patient, within the scope of some level of care being provided, or that is to be provided in the future. The clinical note is stored in an electronic format.

The current application discloses a software program for use by a health care provider to significantly streamline the recordation of information about a patient, form generation, billing and tracking payments, among other tasks. All these functions and more are provided by a single system with an intuitive, easy to understand user interface. Information for insurance claims and business analytics can be entered and calculated through a clinical notes portion of the program. Claim information normally collected through claim forms can be collected during the initial patient demographic intake and throughout the process of clinical charting. Diagnostic information and time and date of service for the diagnostic assessment can be entered onto the system at the time of the diagnostic assessment process. The date of service, length of service, various codes and amounts paid are entered during the time case notes are entered. When the health care provider has entered her diagnostic information and her case notes are completed, she can click “send” and the insurance forms are sent to the clearinghouse for payment. The claims and business data can be entered and calculated from the same screens that are used to enter clinical notes. There is no need to start up a separate module or open a different program.

Through the program, the health care provider can view where claims are in the payment process online, for example. As a result of the streamlined yet comprehensive nature of the system, it is likely that the number of rejected claims due to errors in the claims submitted will be greatly reduced or eliminated. Repeated patterns of rejections due to errors by the insurance company can be tagged and reported to the insurance company. In such an embodiment, if the repeated patterns of rejections due to errors by the insurance company are not remedied, such errors can eventually be reported to a state Attorney General or other legal authority.

A social network, also referred to as a consultation network, links health care providers using the system to a family, creating specially constructed consultation groups according to a health care provider's area of interest and expertise. Clinical information will be downloaded into the system from all kinds of sources to create an internal reference library for health care providers to find answers to their questions.

An artificial intelligence-based search can also be incorporated into the system to search the notes of the health care provider and to then interface with various sources of information that will be described herein to present a diagnostic possibility and other relevant information to the therapist. The search technology can also be applied to the consultation network to read a health care provider's questions to each other through the social network, and then search both internal and external sources to bring back a specific answer. Answers are weighted according to the level of relevance to the questions, and presented in a document. If possible, an exact answer to the question can be highlighted for the therapist. She can save articles found during these searches in her own reference library. Natural language searches can also be achieved through artificial intelligence programming. Artificial Intelligence systems developed by and commercially available from Lymba Corporation in Richardson, Texas is one example system that can be incorporated in the technology disclosed herein.

The system has a number of forms that create the clinical office and through which billing, claims and business analytics are completed. Some examples of these forms are Demographic Intake form, Diagnostic Assessment form, Treatment Plan form, Case Notes form, Multiaxial Assessment form, and Release of Information form.

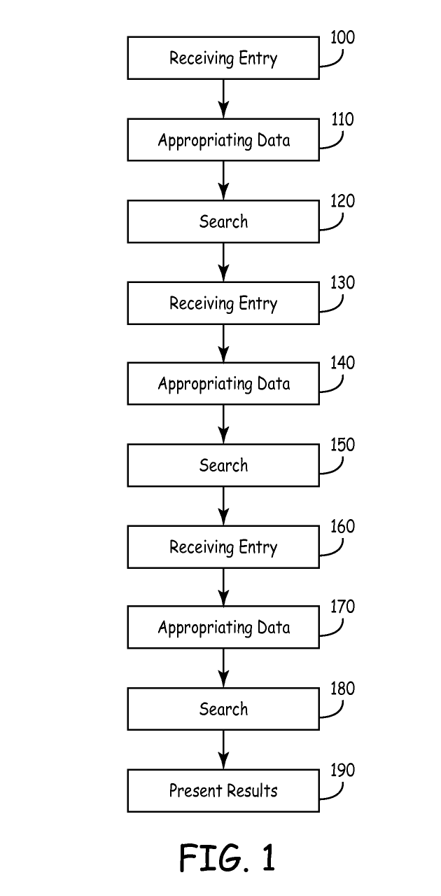

FIG. 1 depicts a flowchart of a method of the technology disclosed herein. A first entry is received 100 by the system, and data is appropriated 110 from the first entry. A search is conducted 120 using the appropriated data. A second entry is received 130 by the system, and data is appropriated 140 from the second entry, and a search is conducted 150. A third data entry is received 160, data is appropriated 170 from the third entry, and a search is conducted 180. Results are presented 190 based on one or more or the searches.

The first entry, second entry, and third entry are generally entries into a clinical note provided by a user. The data fields presented by the system can be relevant to different aspects regarding a patient, symptoms, background and/or patient treatment. The clinical note generally has a plurality of data fields to receive data from the user. As such, the clinical note generally has at least a first field, second field, and third field that are configured to receive the first entry, second entry, and third entry, respectively.

The data fields are generally presented to a user through a user interface such as a computer screen. Data fields can generally be text fields, hyperlinked text, nested lists, radio buttons, and the like, stored on computer-readable media. In a variety of examples data fields can encompass those available with hyper-text mark-up language (html) coding such as input text, text area, input check, input radio, html input button, and html select drop-down boxes, or other computer coding languages. Data is generally entered into the data fields though a user interface such as keyboard, mouse, microphone, touchscreen, and other user interfaces and combinations thereof.

The first entry in the first field of a clinical note is received 110 by the system. Generally the first entry in the first field is entered in by a user through a user interface and will include some data regarding a particular client. The first entry need not necessarily be the first consecutive entry in the clinical note. Likewise, the first field need not necessarily be the first consecutive field in the clinical note. The first entry could be any particular entry, just as the first field could be any particular field.

First data is appropriated 110 from the first entry by the system. In one embodiment a processor appropriates 110 first data from the first entry. The first data can be exact language from the first entry, or can be derived data such as concepts, keywords, and the like, associated with the first entry. In at least one embodiment the system derives one or more concepts apparent in the clinical note by using concept definitions that are built within the system. Derived data is generally data that will be relevant to a search query, and can be identified through a variety of means known in the art. In one embodiment derived data is identified through the use of artificial intelligence searching technology. In another embodiment derived data is identified through a search engine that parses the first entry for particular words. Combinations of derived data and exact data can be appropriated.

A search 120 is then conducted using the first data from the first entry in at least one database. Such databases can be relevant to diagnoses, treatment, current research studies, research articles, any other types of results that could be helpful to a health care practitioner. In various embodiments diagnostic manuals and clinical handbooks are searched 120 based on the first data. In one embodiment relevant to behavioral psychology, the Diagnostic and Statistical Manual of Mental Disorders is searched 120. In another embodiment, the Physician's Desk Reference is searched 120. In various embodiments, an online professional network or consultation network is searched 120 for practitioners practicing in a relevant field, having relevant credentials, publishing research in a relevant field, or even treating a patient with relevant details. Many additional databases can be included in such a search 120. Another particular example is a newsfeed database having news articles for a relatively current time period, such as within the last fifteen years, the last ten years, the last five years, and/or the last 3 years, for example. Another example is a database containing research articles in the user's field of practice or the medical care field of relevance.

Searching 120 for the first data is generally triggered upon receiving 100 at least the first entry of the first field of the clinical note. As follows, appropriating first data 110 from the first entry is also generally triggered upon receiving 100 at least the first entry of the first field of the clinical note. Receiving at least a first entry of a clinical note can be triggered by an indication provided from a user interface initiated by the user.

In one embodiment the indication is a user typing data into the first field. In another embodiment the indication is a user providing indication that the first entry is at least partially provided. Such indication can be, for example, moving the computer cursor or mouse on the user interface to a data field other than the first field, thereby communicating to the system that the user is no longer actively entering data into the first field. Another indication could be pressing the “enter” key on a keyboard, the “tab” key on a keyboard, or an electronic button on a computer screen. Generally stated, the indication can be user progression from the first field to an alternate field

The system then receives at least a second entry in a second field of the clinical note. Similar to the discussion of the first entry of the clinical note, the second entry in the second field of the clinical note need not necessarily be a consecutively second entry in a consecutively second field of a clinical note, but need only be another entry in another field other than the first entry in the first field.

Similar to the first entry in the first field, the system appropriates 140 at least second data from the second entry, where the second data can also be the same data, altered data, or derived data. The system then searches 150 for the first data and the second data in the at least one database. As such, the first data is used with the second data to provide potentially stronger search results. In a variety of embodiments first data is stored while other data entries are being made in the clinical note. In one other embodiment, first data is appropriated again upon obtaining second data. Searching 150 for the first data and the second data is triggered upon receiving 130 at least the second entry of the clinical note, where receiving 130 at least the second entry of the clinical note is conducted by the system in the same or similar manner as receiving at least the first entry 100 of the clinical note, as described above.

The system then receives at least a third entry 160 in a third field of the clinical note. Similar to the discussion of the first entry of the clinical note, the third entry in the third field of the clinical note need not necessarily be a consecutively third entry in a consecutively third field of a clinical note, but need only be another entry in another field other than the first and second entries in the first and second fields. At least the third data is appropriated 170 from the third entry, where the third data can also be the same data, altered data, or derived data

Upon receiving at least the third entry 160 of the clinical note, the system searches 180 for at least the first data, the second data, and the third data in the at least one database, similar to how the first data is searched for in the at least one database. In a variety of embodiments, first data and second data is stored while other data entries are being made in the clinical note. In one other embodiment, first data and second data is appropriated again upon appropriating the third data.

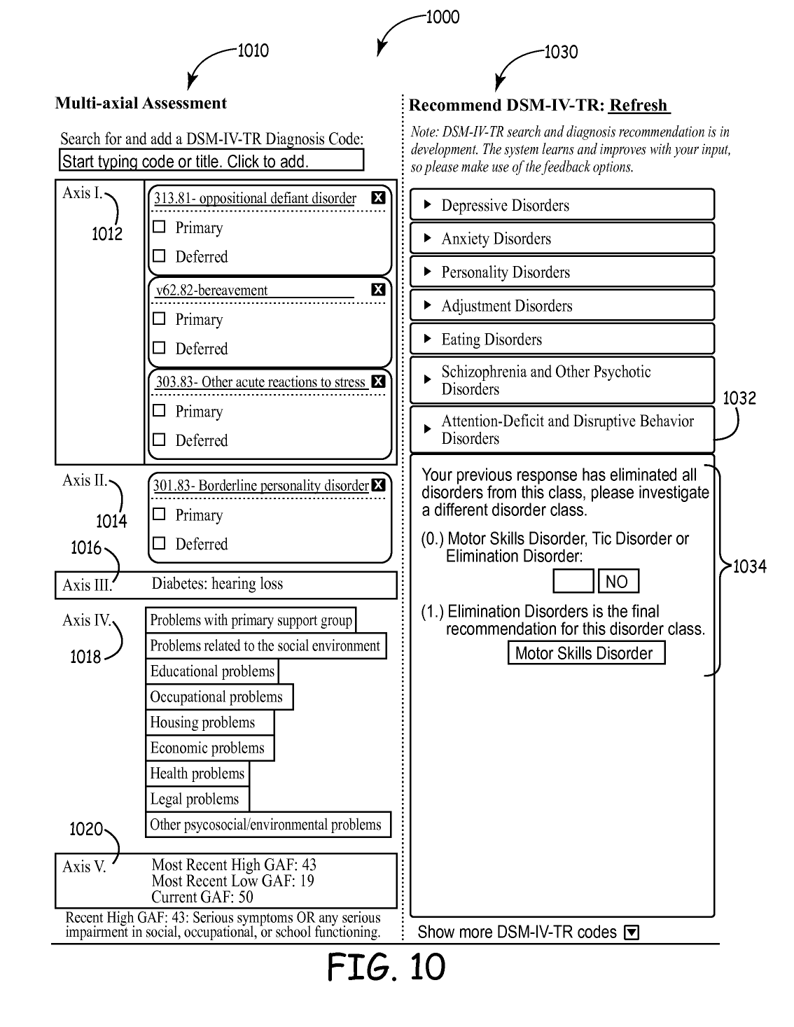

Based on at least one of the searches, the system presents one or more relevant results 190. The results are usually presented 190 through a user interface, wherein the relevant results result from searching the least one database. In a variety of embodiments the results are ranked according to their relevance perceived by the system. In such embodiments, the system may display relevance data for each of the one or more relevant results for the user. The system may incorporate aspects of artificial intelligence to improve predictions of relevance as clinical notes are added to a patient's file. An example screen shot depicting results of an example search is shown in FIG. 10.

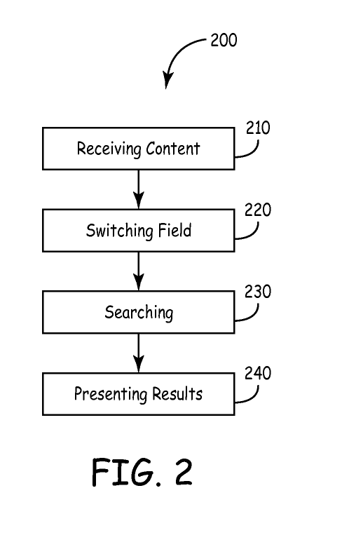

FIG. 2 is another flow chart consistent with at least one alternative embodiment of the technology disclosed herein. Content of a clinical note is received 210, a data field is switched 220, a search is conducted 230, and results are presented 240. For purposes of the technology disclosed herein, “active field” is used to mean a field that is in a state to actively receive data. For example, a text field having a cursor is considered an “active field.” As such, active fields can currently receive data, while inactive fields cannot currently receive data.

The system receives content 210 of a clinical note by receiving a portion of the content of a clinical note in an active first field, where “first field” is not necessarily the consecutively first field on the clinical note, or the consecutively first field to receive data.

The first field is then switched 220 to be inactive. The system generally switches 220 a first field from active to inactive upon activity by the user. For example, as a user progresses from providing an entry in the first field of the clinical note to another field, the first field becomes inactive when another field becomes active. In such an embodiment, a first field can also become inactive upon movement of a user to another page, service, screen, or the like. In another embodiment, the system switches the active first field to be inactive upon the passing of an amount of time. In yet another embodiment, the system switches the active first field to be inactive upon some other criteria. Consistent with the discussion of “active field,” above, an inactive field cannot currently receive text or other data.

Searching at least one database 230 is generally based on the content of the clinical note, and is triggered upon switching 220 the active first field to be inactive. The search can be conducted with data directly obtained from the clinical note, or from data that is derived from the clinical note. In one embodiment the search incorporates natural language search technology based on the content of the clinical note. In at least another embodiment the derived data are concepts appropriated from the clinical note. As such, the system can incorporate artificial intelligence to aid in identifying concepts. Similar to the discussion of FIG. 1, a variety of databases can be searched such as clinical handbooks, consultation networks, and the like. Further, the type of data that is used in the search can be derived or exact data appropriated from the first field of the clinical note.

After conducting the search 230, the system presents one or more relevant results 240 from searching the at least one database on the clinical note. As mentioned in the discussion of FIG. 1, above, the system can display relevance data for each of the one or more relevant results from the user. Results can include any relevant information that may provide some use to medical practitioner, including diagnostic information, research data, referrals, and the like.

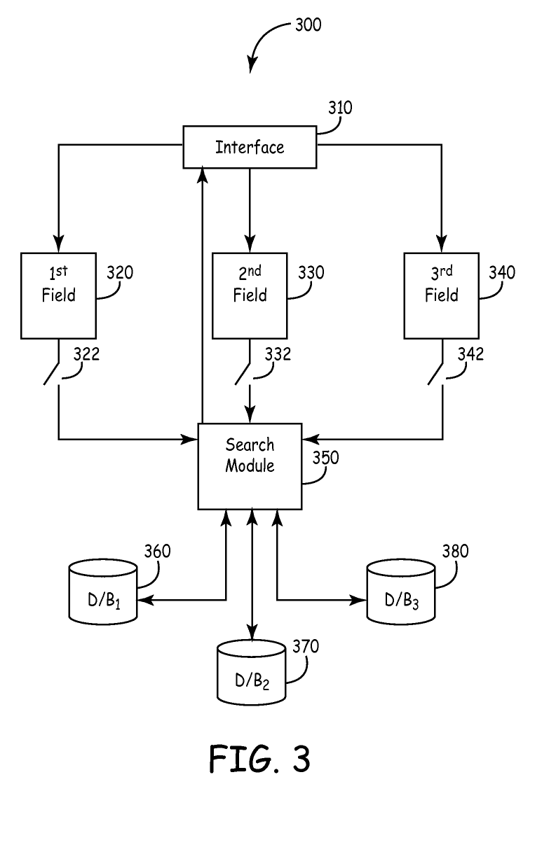

FIG. 3 depicts a schematic consistent with at least one embodiment of the technology disclosed herein. The system depicted in FIG. 3 can be consistent with one of flow charts of FIG. 1 or FIG. 2, in some embodiments. A system-user interface 310 provides a user with access to a first field 320 and second field 330 and a third field 340. The system 300 has a first switch 322, second switch 332, and third switch 343, to selectively allow communication between the first field 320, second field 330, and third field 340, respectively with a search module 350, where the search module is in communication with multiple databases 360, 370, 380. The search module 350 is also in communication with the system-user interface 310 to provide results to a user. In a variety of embodiments, the search module 350 can also provide inquiries to a user to refine the search or search results.

Generally the first field 320, second field 330, and third field 340 will be various fields in a clinical note, within which a user such as a medical practitioner can optionally provide data. Upon the search module 350 receiving the data of the clinical note, the system searches the one or more databases (in this particular embodiment, three databases) 360, 370, 380 for relevant results. Although the first switch 322, second switch 332, and third switch 342 are depicted as physical switches, it will be understood that the switches can merely be conditional software language, for example, providing a basis for occurrence of data transmission to different parts of the system.

In one embodiment, the first switch 322 allows the search engine to use data from the first field 320 upon entry of data by the user into the first field 320. In another embodiment, the first switch 322 allows the search engine to use data from the first field 320 upon switching the first field from active to inactive, as described in the discussion of FIG. 2. The second switch 332 and the third switch 342 can operate similarly to, or the same as, the first switch.

The search module 350 may appropriate data directly from the first field 320, second field 330, and third field 340, or it can be in communication with a system component that appropriates data from the first field 320, second field 330, and third field 340. As described in the discussion of FIGS. 1 and 2, the data appropriated from the first field 320, second field 330, and third field 340 can be the exact data or derived data.

The search engine is in communication with a first database 360, a second database 370 and a third database 380. In at least one embodiment, at least one database is a third-party database rather than an in-system database. Now another system schematic will be described.

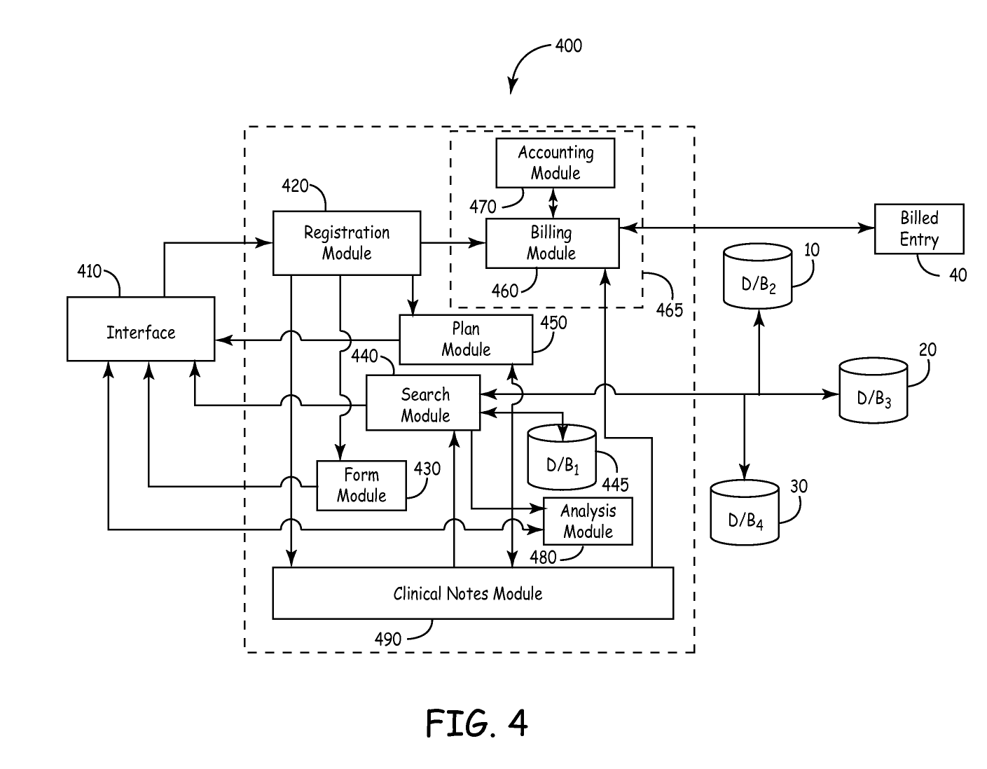

FIG. 4 depicts another system consistent with at least one embodiment of the technology disclosed herein. A system-user interface 410 provides a medical practitioner, for example, with access to system 400 components including a client registration module 420, form module 430, search module 440, one or more databases 445, a plan module 450, a billing module 460, an accounting module 470, an analysis module 480 and a clinical notes module 490. The system 400 can also be in communication with one or more outside databases 10, 20, 30 and a billed entity 40.

As described above, the system interface 410 can be a variety of hardware and software components and combinations thereof. Users can input to and receive output from the system through keyboards, microphones, speakers, touch-pads, touch-screens, computer screens, and the like.

The client registration module 420 is generally for entry and storage of client data, and can particularly receive data during patient intake, but can also be used throughout the medical treatment of a patient. General patient data that is entered in the client registration module 420 can be name, contact phone numbers, medical history data, insurance information, address, and so on. Family member data including aspects of family member health history could also be included, in a variety of embodiments. For purposes of this application, data entered in the client registration module can, in some embodiments, include clinical note data.

The billing module 460 and the accounting module 470 are generally components of a system 400 financial center 465. The billing module 460 is in communication with the client registration module 420 to appropriate at least a portion of client data to create an insurance claim. In multiple embodiments the billing module 460 also receives data after completion of a clinical note from the clinical notes module 490 to create the insurance claim. After completion of the insurance claim, the billing module 460 can send the insurance claim to the insurance provider or to an insurance clearinghouse associated with the insurance provider. In at least one embodiment the billing module 460 is in communication with one or more insurance providers and is notified when payments are made to the medical practitioner in response to an insurance claim.

The accounting module 470 in the financial center 465 is further configured to generate an accounting report. As such, the accounting module 470 is in communication with the insurance billing module 460 to track insurance claims and report accounting status. In one embodiment the accounting module 470 can analyze financial transactions and report trends in data. In one embodiment, the accounting module 470 can provide indication as to which areas of practice are making money and losing money in a general practice clinic, for example. In another example, the accounting module 470 can provide data relevant to payment waiting times associated with various insurance providers. Other types of data can be provided as well. Data can be presented through flow charts, bar graphs, pie charts, and the like.

The accounting module 470 can also process electronic payments, in some implementations. In such an implementation the accounting module 470 is in electronic communication with a bank account of the medical practitioner or clinic to receive payment from an entity and transfer the payment to the bank account. The accounting module 470 can also receive payment data from a user in events where a user receives payment in person rather than electronically.

The clinical notes module 490 generally receives content of clinical notes regarding a client. Generally the clinical notes module 490 receives content of a clinical note during or shortly after an appointment with a client. Such data can include client procedural treatment codes, place of service, date of birth, primary party, duration and date of service, and so on. The clinical notes module 490 can include the registration module 420 in a variety of embodiments, as the modules can generally include overlapping data. The clinical notes module appropriates at least a portion of client data from the registration module 420 to the clinical note. For example, the client's name and contact information can be appropriated to the clinical note, as well as diagnostic codes, insurance billing codes, client procedural treatment codes, and the like.

Other data can also be appropriated by the clinical notes module 490 to the clinical note. For example, date and duration information of the appointment can be in communication with a scheduling calendar, or the current date and time, if known by the system. In one embodiment the clinical notes module 490 can time the duration of the appointment where the clinical notes module 490 is accessed throughout the duration of the appointment, and such data can be used to create insurance claims, as will be described.

The clinical notes module 490 can also trigger the insurance billing module 460 to create an insurance claim. As described above, the insurance billing module 460 can be triggered to create an insurance claim upon completion of the clinical note. In another embodiment, the insurance billing module 460 can be triggered to create an insurance claim upon indication by the user of that intention, such as through selecting an electronic button on the user interface or the like. As described above, the accounting module 470 can also be in communication with the clinical notes module 490 and be triggered by the completion of a clinical note to prepare an accounting summary.

An aspect of the system is that a user is able to enter client, insurance and service information into only one system which is capable of recording clinical notes, generating and submitting insurance claim forms, and tracking when payment is received. In the past, a user has had to interact with two or three different software programs to perform the same tasks.

Consistent with an embodiment described in the discussions of FIG. 1, FIG. 2, or FIG. 3, the search module 440 is configured to search at least one database 445, 20, 30, 40 while receiving the content of a clinical note. The search module 440 is also configured to display at least one search result from the search. As described above, the results can be ranked and can communicate the relevance of each result to the user. The search module 440 can appropriate data from the clinical note that is either derived data or actual data.

The one or more databases 445, 20, 30, 40 can be third party databases or in-system databases. Databases can be consistent with the discussion of the databases associated with FIG. 1, FIG. 2, and FIG. 3 and so can include manuals, guidelines, professional network, handbooks, and the like. In-system databases can include currently treated or past-treated clients/patients, client history, clinic medical practitioners with relevant expertise, and other in-house documents.

The treatment plan module 450 automatically populates a treatment plan using at least a portion of the content of the clinical notes and at least a portion of client data. The treatment plan module 450 can appropriate relevant diagnostic data, historical data, symptoms, and the like, to prepare and present a treatment plan to the user. In a variety of embodiments the treatment plan module 450 also populates a clinical note with relevant treatment plan data.

The form creation module 430 to automatically appropriates at least a portion of client data to generate relevant forms selected by the user. Such forms can include Health Insurance Portability and Accountability Act (HIPAA) forms, suicide prevention contracts, information release forms, referral forms, and the like. In one embodiment the system 400 can automatically generate a form without request by the user in circumstances where the system identifies necessity of such a form based on content of a clinical note or the registration module.

The analysis module 480 is generally used to present inquiries to the user to refine the at least one search result from the search module 440. The analysis module 480 can incorporate artificial intelligence technology to present relevant queries to the user to rule out particular conflicting results, such as diagnoses for conflicting conditions.

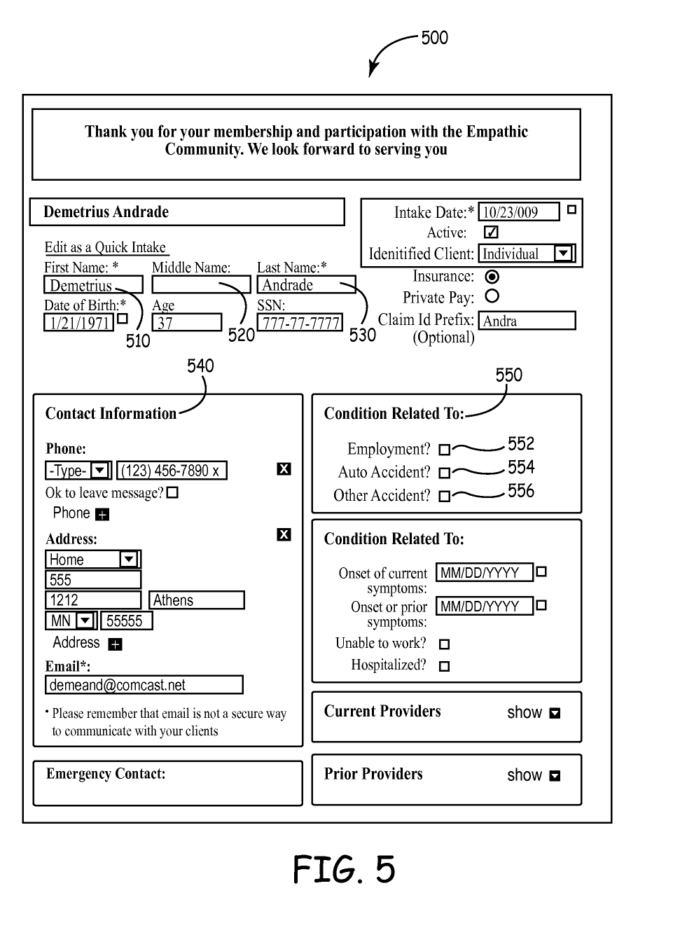

FIG. 5 is a first example screenshot related to client intake for a system consistent with the technology disclosed herein. The example screenshot 500 can be associated with the registration module 420 (See FIG. 4), where a client is initially registered. The intake screenshot 500 has a first field 510 a second field 520 and third field 530, for example, that are configured to receive the client's first name, middle name, and last name, respectively. A portion of the screen 500 provides fields configured to receive contact information 540 such as telephone number, street address, e-mail address, and the like. A “Condition Related To” section 550 provides a first field 552, a second field 554, and a third field 556, where a user can indicate whether the condition relates to the text associated with each field. A number of other fields used for client intake are visible in FIG. 5.

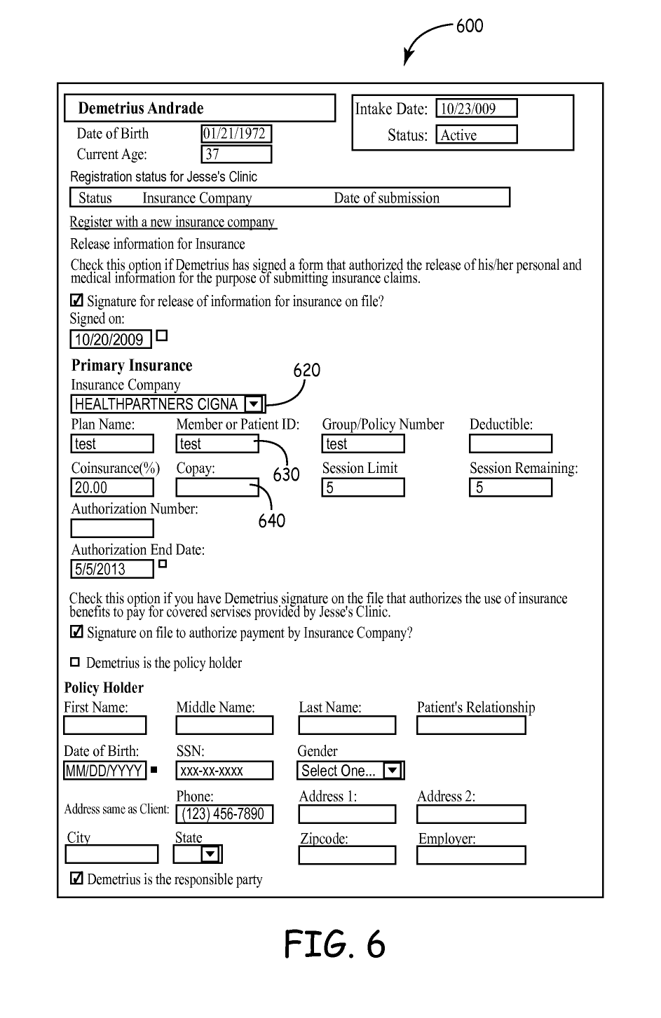

FIG. 6 is a second example screenshot related to client intake for a system consistent with the technology disclosed herein. The example screenshot 600 can also be associated with the registration module 420 (See FIG. 4), where a client is initially registered. A first field 620 allows user selection of the client's insurance company, a second field 630 allows the user to provide the client's insurance identification or member number, and a third data field 640 allows the user to provide the client's co-pay information. A number of other fields used for client intake are visible in FIG. 6.

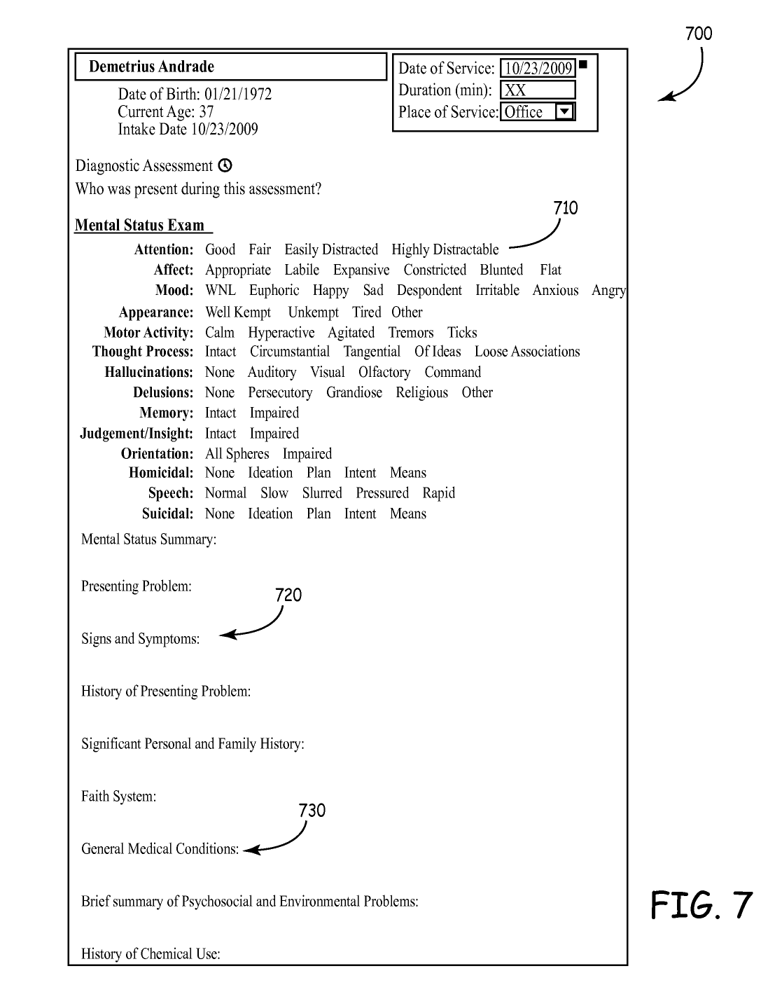

FIG. 7 is a third example screenshot related to client intake for a system consistent with the technology disclosed herein. The example screenshot 700 can be associated with a clinical note and is generally for the initial diagnostic assessment. A first field 710 requests that a user selects one option out of four possibilities with regard to the client's attention level. A second field 720 is provided for a user to enter text regarding the client's signs and symptoms. A third field 730 is provided for a user to enter text associated with the client's general medical conditions. A number of other fields used for client intake and clinical notes are visible in FIG. 7.

Consistent with the discussions of FIGS. 1-3, above, a search module can be in communication with the system and appropriate data from the clinical note 700 upon receipt of an entry by the user in a data field. The search module can then search for the appropriated data to receive one or more search results.

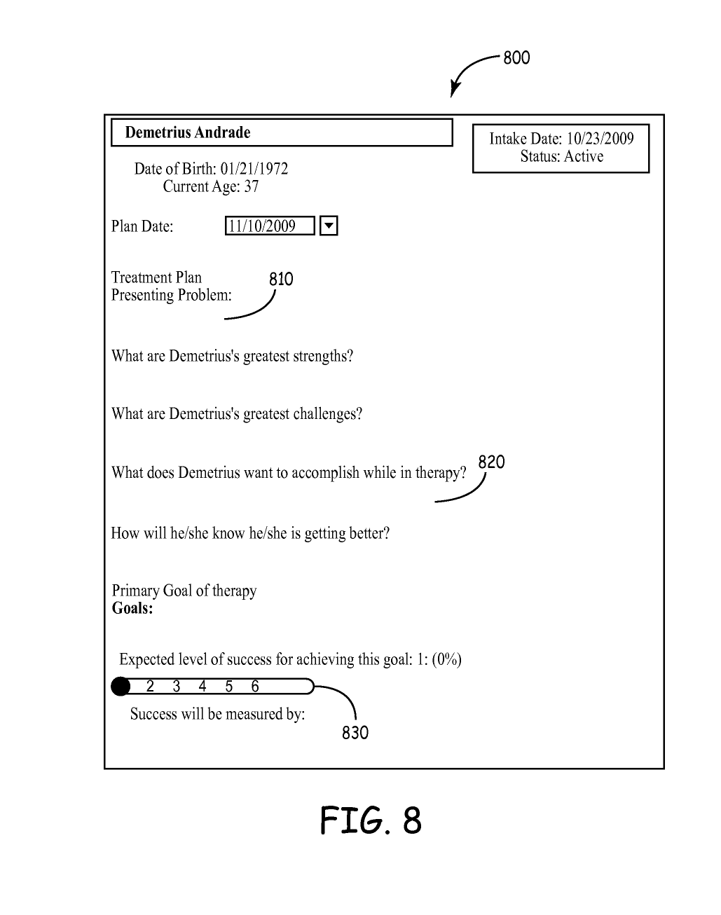

FIG. 8 is an example screenshot related to creation of a treatment plan for a system consistent with the technology disclosed herein. The example screenshot 800 is also associated with a clinical note and is generally for creation of the treatment plan. A first field 810 is provided for a user to enter text regarding the client's presenting problems. A second field 820 is provided for a user to enter text regarding the client's goals for therapy. A third field 830 is provided for a user to indicate the user's expected level of success for achieving this goal.

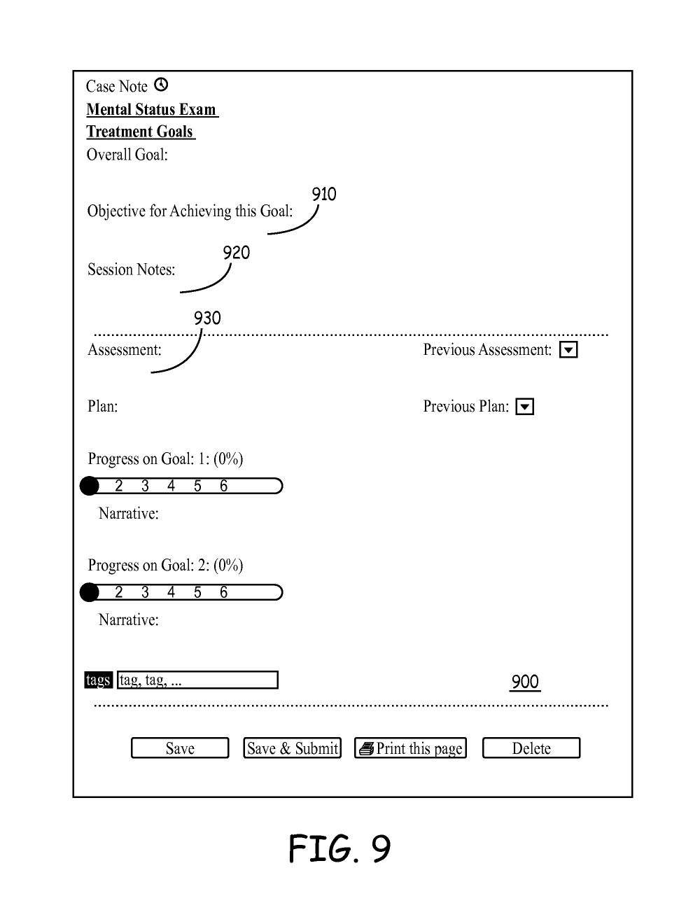

FIG. 9 is an example screenshot related to creation of a case note for a system consistent with the technology disclosed herein. The example screenshot 900 is also associated with a clinical note and is generally for following up with a client. A first field 910 is provided for a user to enter text regarding objectives. A second field 920 is provided for a user to enter text of the session notes. A third field 930 is provided for a user to enter text of assessment notes.

FIG. 10 is an example screenshot related to presenting search results for a system consistent with the technology disclosed herein. Although the search results are depicted as consistent with behavioral health, other medical fields are also contemplated. The assessment fields 1010 are provided for a medical practitioner to indicate particular medical assessments made for the patient. In the field of behavioral health, different areas of health are classified into different “axes,” such as Axis I 1012, Axis II 1014, Axis III 1016, Axis VI 1018, and Axis V 1020. The assessment fields can be organized in groups according to these axes. In other areas of practice, different criteria for organizing and grouping assessment fields can be used.

The Recommendations 1030 by the system are provided as search results for the medical practitioner based on client data found in clinical notes and other client data. The results 1030 are presented in a nested list, where a user can elect a category heading 1032, and category information 1034 under the heading 1032 is presented. The category information 1034 can be further classification data such as sub-categories, or refinement inquiries to rule out particular options under the category heading. In this particular example, the category information 1034 indicates that the particular category heading 1032 can be eliminated as an option. The system can also provide the option for the user to automatically insert a category heading from the recommendations 1030 to the practitioner's assessment 1010 and diagnosis. Such selection of a can also be appropriated by the system to insurance claims, various generated forms, and the like.

As described in the discussion of FIG. 1, the search can also include searching a professional network or consultation network for other professionals who might be relevant to the issues presented to the user based on experience, a current client, publications, credentials, and so on. In such a scenario a contact link for a professional can be provided to the user so that the user can request that the professional become a colleague on the consultation network. A contact link can send an electronic note to the professional through an online network, for example, or could also provide an electronic e-mail address, or a phone number. The search results can indicate why the particular professional has been recommended, or such data can remain private. As described in the discussion of FIG. 1, the search can also include searching a newsfeed for relevant, timely research. Such results can also be presented to the user. Other results can also be presented to a user based on the search conducted.

A feature of certain embodiments of the system is that a search is launched during the course of the entry of information into fields, without a need for the user to take a separate step to initiate the search. While a user is entering information about a patient or client in a clinical note, the system starts searching for relevant information that may be useful to the user, such as diagnosis codes or research articles.

For example, in a behavioral health setting, a clinical note indicating that a patient presents with frequent crying, panic attacks, exhaustion, and excessive consumption of alcohol may result in search results of: alcoholism, depression, and anxiety. By adding content to the clinical notes over the course of seeing the patient, the system can rule out options and refine the search results. For example, the patient may very well have anxiety or depression resulting from post-traumatic stress disorder (PTSD), which would also be presented as a result.

Also, by personally assessing the patient, the medical professional can use their professional intuition and expertise to rule out some options and include other options. For example, the medical professional may decide that the exhaustion is unrelated to behavioral health issues and may be related to a different medical condition such as sleep apnea or narcolepsy. The system allows the medical professional to make such determinations, which are then reflected in the patient's clinical notes, by selecting diagnosis to rule out (and also selecting diagnosis to apply). After the diagnoses are determined by the medical professional and entered into the system, they are appropriated to clinical notes, insurance claims, and other forms as needed. Furthermore, in the example above, the medical professional may also use the search functions of the current systems to refer the client to a medical professional specializing in sleep conditions or appropriate the data to automatically fill out a referral form.

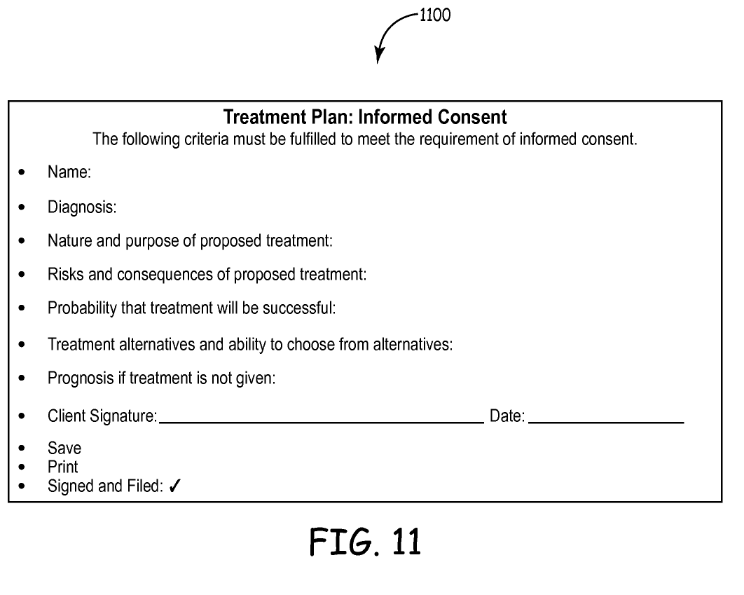

FIG. 11 is an example generated form consistent with the technology disclosed herein. As described in the discussion of FIG. 4, the form module 430 is configured to automatically generate forms associated with the client. This example form is an Informed Consent contract for the client with regard to the treatment plan. Such data can be appropriated from other client data to populate this form. For example, data can be appropriated from a treatment plan similar to that depicted in FIG. 8.

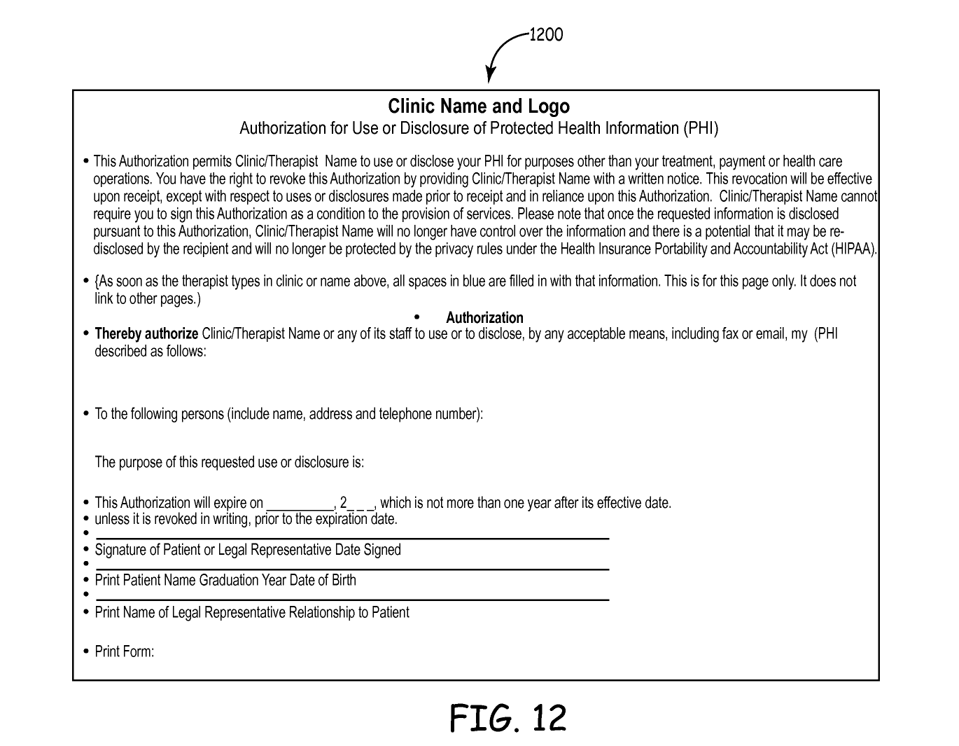

FIG. 12 is another example generated form consistent with the technology disclosed herein, and is an Information Release form 1200. The form generating module can be configured to generate a variety of other documents such as referral forms, progress report forms, case consultation forms, suicide prevention contracts, HIPAA forms with instructions about where the therapist's personal information belongs, and standard treatment plan forms that can be saved with a link on left navigation. Many other forms can also be generated by the system.

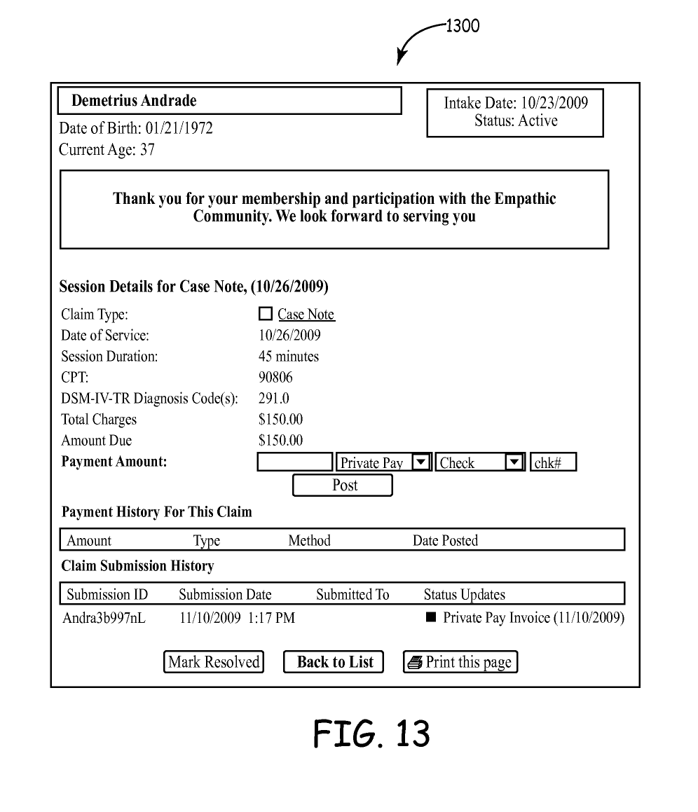

FIG. 13 is an example screenshot related to a financial center for a system consistent with the technology disclosed herein. Upon completion of a case note, such as that depicted in FIG. 9, the financial center logs the history of the claim, session details, and payment history.

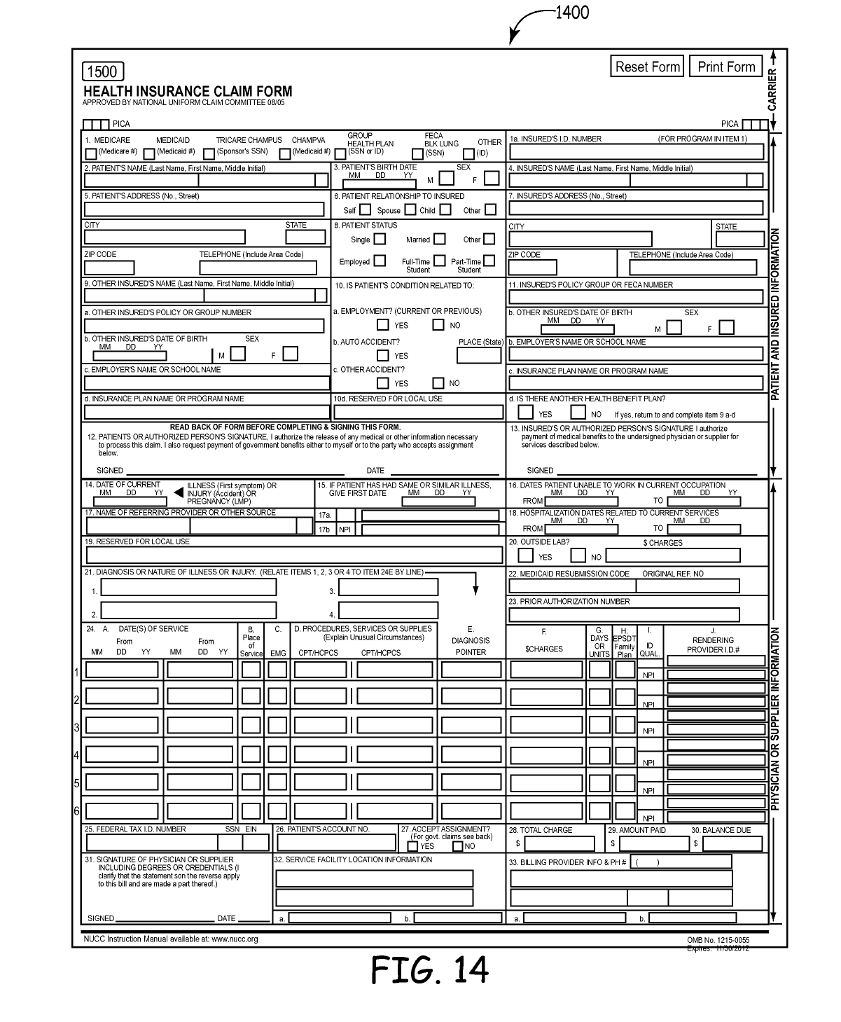

FIG. 14 is an example insurance claim consistent with the technology disclosed herein. Insurance claims are generally standardized. The system described herein can appropriate client data and clinical note data to populate the insurance claim form, and send the insurance claim form to the proper receiving entity. The proper receiving entity can be an insurance clearing house, for example, or an insurance company, in another example.

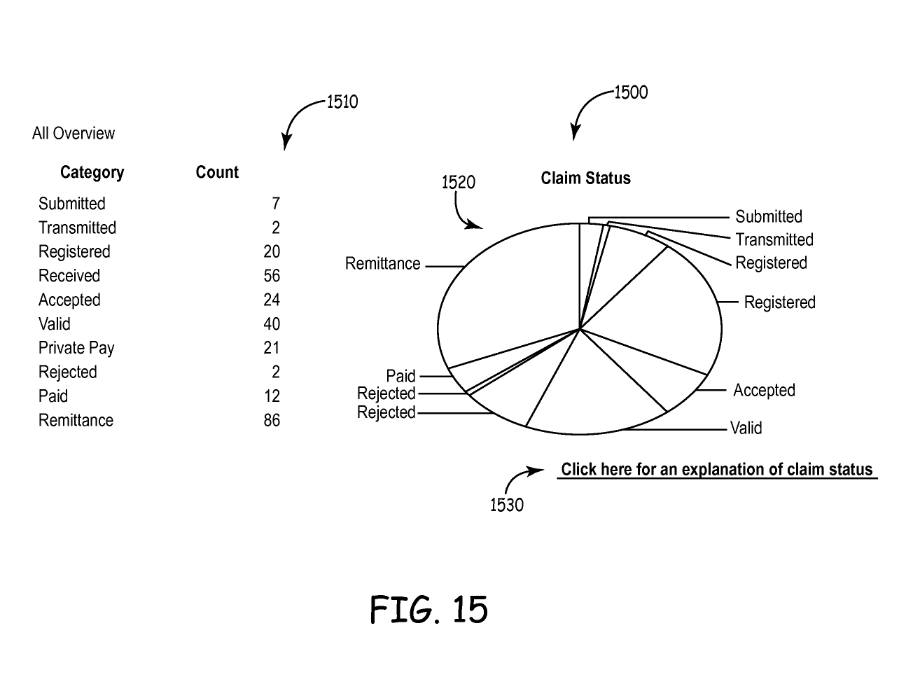

FIG. 15 is an example screenshot related to the financial center for a system consistent with the technology disclosed herein. In a variety of embodiments, the accounting module described in the discussion of FIG. 4 can generate a variety of reports. The example report 1500 of FIG. 14 provides a user with an overview of the claim statuses in a chart 1510 and a pie chart 1520. The user also has the option of selecting a first field 1530 to be provided with more detailed information.

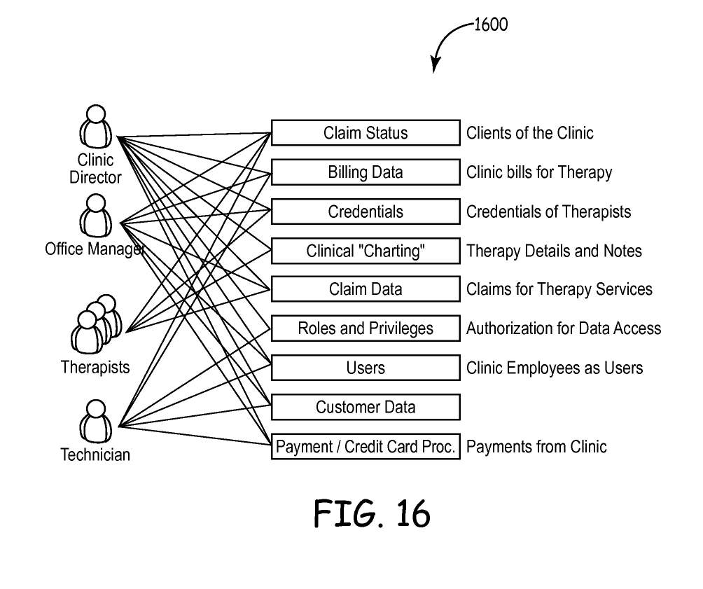

FIG. 16 is an example schematic of software access in a clinic consistent with one embodiment of the technology disclosed herein. In an integrated system incorporating vast amounts of user data, clinic data, and client data it can be beneficial to have varying levels of security associated with clinic staff Privacy will be managed through privilege management and flagging.

With regard to privilege management, users can be assigned roles. Records can be stored in a security database, and can be programmed to define which data, screens and functions are accessible to each user role. Different levels of access may include defining clinical notes as read-only to those users having one role, and as read-write to those users having another role. Users can additionally flag individual records for confidentiality. Flagging can, for example, prevent records from showing up on reports. In another example, flagging can prevent the records from being viewed by anyone except the assigned medical practitioner and the director of the clinic.

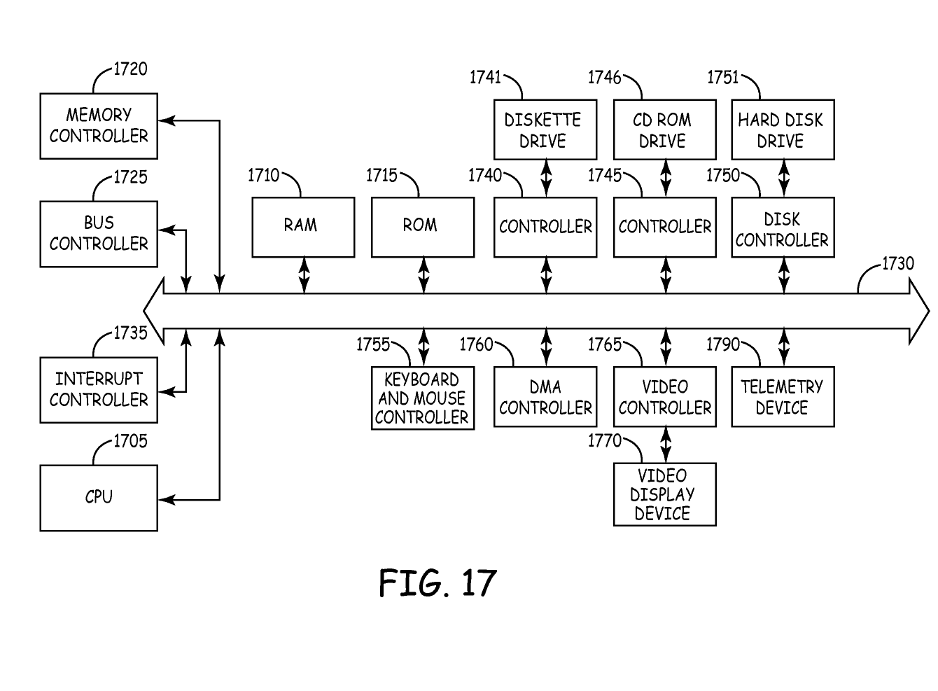

It will be appreciated that the clinical management system of various embodiments can include a variety of specific components in order to carry out specific functions and methods as described herein. Referring now to FIG. 17, a diagram of various components that can be included in a clinical management system is shown in accordance with an embodiment of the invention. The system can include control circuitry including, for example, a central processing unit (CPU) 1705 or processor, which may include a conventional microprocessor, random access memory (RAM) 1710 for temporary storage of information, and read only memory (ROM) 1715 for permanent storage of information. The memory (RAM and/or ROM) can have instructions stored thereon causing the external medical device programmer to execute various steps and methods described herein. By way of example, the memory can have instructions stored thereon causing the external medical device programmer to implement the functionality discussed throughout this application, for example. A memory controller 1720 is provided for controlling system RAM 1710. A bus controller 1725 is provided for controlling data bus 1730, and an interrupt controller 1735 is used for receiving and processing various interrupt signals from the other system components.

Mass storage may be provided by diskette drive 1741, which is connected to bus 1730 by controller 1740, CD-ROM drive 1746, which is connected to bus 1730 by controller 1745, and/or a hard disk drive 1751, which is connected to bus 1730 by controller 1750. User input to the system may be provided by a number of devices. For example, a keyboard and mouse can connected to bus 1730 by keyboard and mouse controller 1755. Direct memory access (DMA) controller 1760 is provided for performing direct memory access to system RAM 1710. A visual display is generated by a video controller 1765, which controls video display 1770. The system can also include a telemetry interface circuit 1790 or wireless communications module that allows the system to interface and exchange data with non-local devices and components. It will be appreciated that in various embodiments not all of the components depicted in FIG. 17 will be present.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”, “manufactured and arranged”, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

This application is intended to cover adaptations or variations of the present subject matter. It is to be understood that the above description is intended to be illustrative, and not restrictive.

We claim:

1. A method comprising:
receiving at least a first entry in a first field of a clinical note;
appropriating at least first data from the first entry;
searching for the first data from the first entry in at least one database, wherein searching for the first data is triggered upon receiving at least the first entry of the first field of the clinical note;
receiving at least a second entry in a second field of the clinical note;
appropriating at least second data from the second entry;
searching for the first data and the second data in the at least one database, wherein searching for the first data and the second data is triggered upon receiving at least the second entry of the clinical note;
receiving at least a third entry in a third field of the clinical note;
appropriating at least third data from the third entry;
searching for the first data, the second data, and the third data in the at least one database, wherein searching for the first data, the second data, and the third data is triggered upon receiving at least the third entry of the clinical note; and
presenting one or more relevant results through a user interface, wherein the relevant results result from searching the least one database.

2. The method of claim 1, wherein:
appropriating at least first data from the first entry further comprises deriving concepts from the first entry,
appropriating at least second data from the second entry further comprises deriving concepts from the second entry, and
appropriating at least third data from the third entry further comprises deriving concepts from the third entry.

3. The method of claim 1, wherein the database includes a consultation network.

4. The method of claim 1, wherein the database includes a clinical handbook.

5. The method of claim 4, wherein the database includes the DSM Handbook.

6. The method of claim 1, further comprising displaying relevance data for each of the one or more relevant results from the user.

7. The method of claim 2, incorporating artificial intelligence technology.

8. The method of claim 1, wherein receiving at least a first entry of a clinical note is triggered by an indication provided from a user interface.

9. The method of claim 8, wherein the indication is based on user progression from the first field to an alternate field.

10. A method comprising:
receiving a portion of the content of a clinical note in an active first field;
switching the active first field to be inactive;
searching at least one database based on the content of the clinical note, wherein searching is triggered upon switching the active first field to be inactive; and
presenting one or more relevant results resulting from searching the at least one database on the clinical note.

11. The method of claim 10, wherein searching the at least one database based on the content of the clinical note comprises appropriating data from the first field and searching for that data in the at least one database.

12. The method of claim 10, where searching for the phrase uses natural language search technology.

13. The method of claim 10, wherein the database includes a consultation network.

14. The method of claim 10, wherein the database includes a clinical handbook.

15. The method of claim 14, wherein the database includes the DSM Handbook

16. The method of claim 10, further comprising displaying relevance data for each of the one or more relevant results from the user.

17. The method of claim 10, incorporating artificial intelligence technology.

18. A clinical note system comprising:
a client registration module for entry and storage of client data;
an insurance billing module in communication with the client registration module to appropriate at least a portion of client data to create an insurance claim and send an insurance claim; and
a clinical notes module for receiving content of clinical notes regarding a client, appropriating at least a portion of client data to a clinical note, and triggering the insurance billing module to create an insurance claim upon completion of the clinical note.

19. The system of claim 18, further comprising a financial center to receive financial data upon completion of the clinical note.

20. The system of claim 19, wherein the financial center is further configured to generate an accounting report upon completion of the clinical note.

21. The system of claim 18, further comprising a search module to search at least one database while receiving content of clinical notes and display at least one search result.

22. The system of claim 18, further comprising a treatment plan module to automatically populate treatment plan using at least a portion of the content of the clinical notes and at least a portion of client data.

23. The system of claim 18, further comprising a form creation module to automatically appropriate at least a portion of client data to generate at least one of the following forms in the group consisting of:
HIPAA forms, suicide prevention contracts, and information release forms.

24. The system of claim 18, further comprising an analysis module to present inquiries to the user to refine the at least one search result.

25. The system of claim 18, further comprising an accounting module in communication with the insurance billing module to track insurance claims and report accounting status
